(19) United States
(12) Patent Application Publication
(10) Pub. No.: US 2003/0098783 A1
(43) Pub. Date: May 29, 2003

(54) Transponder reading device

(76) Inventor: Frederic Pagnol, La Gaude (FR)

Correspondence Address: SCHWEITZER CORNMAN GROSS & BONDELL LLP, 292 MADISON AVENUE - 19th FLOOR, NEW YORK, NY, 10017, US

(21) Appl. No.: 10/168,006

(22) PCT Filed: Dec. 14, 2000
(86) PCT No.: PCT/FR00/03523

(30) Foreign Application Priority Data
Dec. 15, 1999 (FR) 99/15805

(51) Int. Cl. G06K 7/00

(52) U.S. Cl. 340/10.1

(57) ABSTRACT

Read device (100) including a power stage and a read antenna (110) making it possible to generate an electromagnetic field for excitation of at least one transponder (10) situated in the field of the antenna, this transponder including a receiving antenna (11) and associated changeover-switching means (12) allowing it to modify the state of the receiving antenna and thus to transmit information to the read device, by modification of the coupling between the read antenna and the receiving antenna.

The read device includes detection means which are configured to reduce the noise or the fluctuations, in the signal from the antenna, which are due to the electronic components of the power stage, and to generate a useful signal from the change in the signal from the read antenna by comparison with a reference signal, this reference signal being representative of the signal from the read antenna when the receiving antenna of the transponder is in a predetermined state, the useful signal being representative of the changes of state of the receiving antenna.

The present invention relates in a general way to the identification of objects or of persons by means of transponders by virtue of a read device making it possible to read information stored in the transponders, or even to exchange information with them.

The invention relates more particularly to a read device of the type including a power stage and a read antenna making it possible to generate an electromagnetic field for excitation of at least one transponder situated in the field of the antenna, this transponder including a receiving antenna and associated changeover-switching means allowing it to modify the state of the receiving antenna and thus to transmit information to the read device, by modification of the coupling between the read antenna and the receiving antenna.

Each transponder receives the electrical energy necessary for its operation from the read antenna.

It is difficult to extract, from the signal from the read antenna, a useful signal representative of the information originating from the transponder, because the coupling modifications induced by the changes in the state of the receiving antenna are extremely slight and close to the thermal and shot noise in the case of a small-sized tag situated a long way from the antenna.

These difficulties are increased by the fact that the regulations stipulate that a given transmission power is not exceeded in the frequency band used and that no harmonics are generated in other frequency bands.

A read device aiming to reduce the amplitude of the carrier in order to facilitate detection is known from the application GB 2 333 665.

This device includes high-pass and low-pass filters in order to generate two signals, one of them a reference signal. This device does not make it possible to cancel out the noise due to the electronic components of the power stage.

The subject of the invention is a novel read device capable of complying with the regulations while exhibiting sufficient sensitivity to read the information transmitted by a transponder placed in the field of the read antenna.

The read device according to the invention is characterized in that it includes detection means which are configured to reduce the noise or the fluctuations, in the signal from the antenna, which are due to the electronic components of the power stage and to generate a useful signal from the change in the signal from the read antenna by comparison with a reference signal, this reference signal being representative of the signal from the read antenna when the receiving antenna of the transponder is in a predetermined state, the useful signal being representative of the changes of state of the receiving antenna.

By virtue of the invention, it is possible, because of the use of a reference signal, to detect variations in the coupling of the order of 10⁻⁶ between the read antenna and the receiving antenna.

In a first implementation of the invention, the read device includes changeover-switching means which are configured to feed the read antenna in pulsed mode and the detection means include processing means which are configured to perform damping demodulation of the signal from the read antenna after each pulse.

The invention then takes advantage of the fact that the oscillations of the antenna after each pulse are damped in a way which depends on the coupling between the read antenna and the receiving antenna.

Any modification to this coupling entails a modification in the damping which is detected by the read device in order to extract the information transmitted by the transponder.

This information is relatively easy to extract by reason of the fact that, after each pulse, the read antenna oscillates freely, in such a way that its signal is not polluted by the noise from the electronic components of the power stage having served to excite the antenna.

Advantageously, the abovementioned processing means include a peak detector in order to preserve the peak amplitude of the signal from the read antenna over a predetermined pseudo-period, for example the third pseudo-period, this pseudo-period selected for the measurement preferably being the one which is the most favorable from a signal/noise point of view, or the one where the peak amplitude is close to 1/e of the initial amplitude.

In one particular embodiment of the processing means, they include peak-limiting means for peak-limiting the signal from the read antenna for a predetermined period preceding the pseudo-period selected for the measurement.

In another implementation of the invention, the read antenna is excited by a signal with a low harmonic content, preferably output by a class-E switching amplifier, and the read device includes processing means configured to perform impedance demodulation.

In one particular embodiment, the read device includes a directional coupler configured in such a way that a modification of the coupling between the read antenna and the receiving antenna gives rise to a useful signal representative of the de-tuning of the read antenna induced by the changes of state of the receiving antenna.

Still in a particular embodiment, the reference signal is obtained by means of a compensation arm the impedance of which is equal, to within a known factor, to that of the read antenna when the receiving antenna is in a predetermined state.

Advantageously, the read device includes a torus with three coils, including a first coil linked in series with the compensation arm, a second coil linked in series with the read antenna and mounted in phase opposition with the first coil, in such a way that the flux in the torus is zero when the impedance of the antenna is equal, to within a known factor, to that of the compensation arm, and a third coil making it possible to detect a flux variation in the torus.

In one particular embodiment, the compensation arm includes variable components which are controlled in such a way as to cancel out the flux in the torus due to the slow variations in the impedance of the read antenna.

In another particular embodiment, the compensation arm includes components of fixed values, and the torus includes a fourth coil supplied with current in such a way as to cancel out the flux in the torus due to the slow variations of the read antenna.

The fact of exciting the read antenna with a signal exhibiting a low harmonic content has the advantage of allowing the read antenna to be fed with a relatively substantial current with no fear of polluting the radio-frequency spectrum.

In a general way, the read antenna is advantageously split into at least two coils linked in series by a tuning capacitor arranged within a screening.

This screening can be open at at least one of its axial extremities, so as to allow articles equipped with transponders to pass into the read antenna.

The screening is advantageously split so as not to dissipate induced currents.

The fact of splitting the read antenna into at least two coils makes it possible to position the terminals of these coils, which are subject to overvoltages, within the screening, which makes the antenna more reliable and also makes it possible to reduce its sensitivity to stray effects, to the effects of static potentials, also called hand effects, and to humidity, and to increase the resulting quality factor.

Furthermore, certain components of the read antenna are then subjected to lower voltages and age better.

In one particular embodiment, the read antenna includes a first set of coils arranged within the field produced by a second set of coils, these coils being linked together in such a way as to constitute a four-pole antenna, outside which the far magnetic field decreases as 1/d⁵.

By virtue of this rapid decrease in the far magnetic field, it is possible to arrange several read devices in the same enclosure without that posing problems of interference between the read antennas.

In one particular embodiment, the frequency to which the read antenna is tuned lies between 100 and 150 kHz, especially 119-135 kHz, which makes it possible to confer a relatively extensive range on the antenna.

In one particular embodiment, the frequency with which the receiving antenna is switched is at least 16 times lower than the frequency to which the read antenna is tuned.

When the read antenna is configured to receive a container containing a plurality of articles each equipped with a transponder, the read device is preferably used with impedance demodulation, in which the read antenna is fed with a signal with a low harmonic content, preferably output by a class-E switching amplifier.

The transmission power of the read antenna may, in this case, be relatively high, so that the latter can cover a substantial detection volume.

In another particular embodiment, it is sought rather to have a read antenna featuring small size and low cost.

In this case, the read device is preferably used with damping demodulation.

In all cases, the read device advantageously includes a gauge transponder fastened to the read antenna, this gauge transponder being active during phases of testing of the read device and possibly being placed in a silent mode when the said test phases are terminated.

When the transponders used are of the read and the write type, the read device advantageously includes changeover-switching means making it possible to modulate the feed to the read antenna, so as to transmit information to the transponders placed in the field of the antenna.

Preferably, in the case of all-or-nothing modulation, the read device includes a circuit for damping the oscillations of the read antenna, comprising changeover-switching means for linking a coil placed in the field of the read antenna or a reactive element of the antenna to a dissipative load, when it is necessary to damp the oscillations of the antenna rapidly.

A further subject of the invention is a set of devices as defined above.

In this case, the clocks of the devices are advantageously synchronized.

Moreover, they are preferably driven in such a way that none of them operates in write mode when another one is operating in read mode.

Other characteristics and advantages of the present invention will emerge on reading the detailed description which will follow of nonlimiting implementation examples, and on examining the attached drawing, in which:

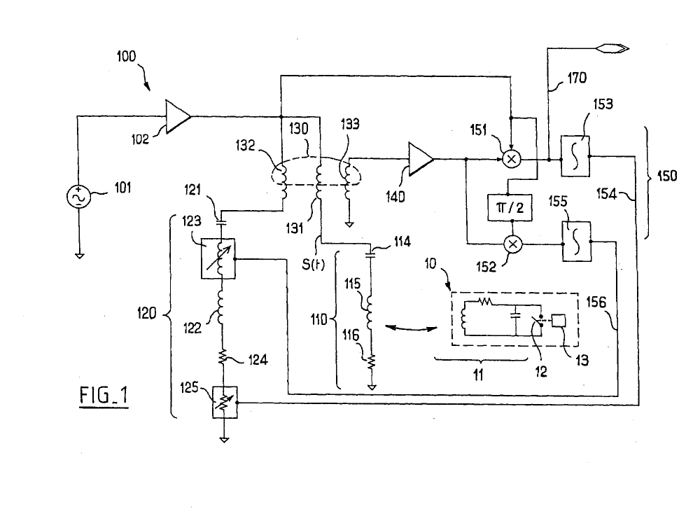

FIG. 1 is a diagram of a read device in accordance with a first embodiment of the invention,

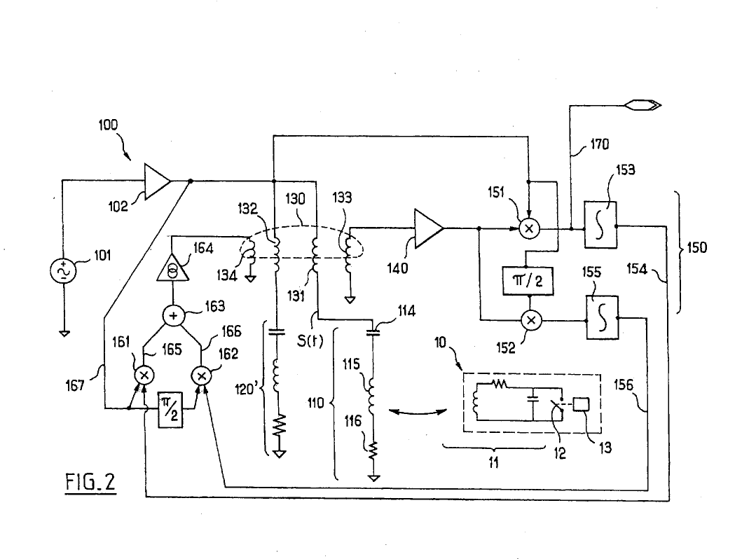

FIG. 2 represents a variant of the device of FIG. 1,

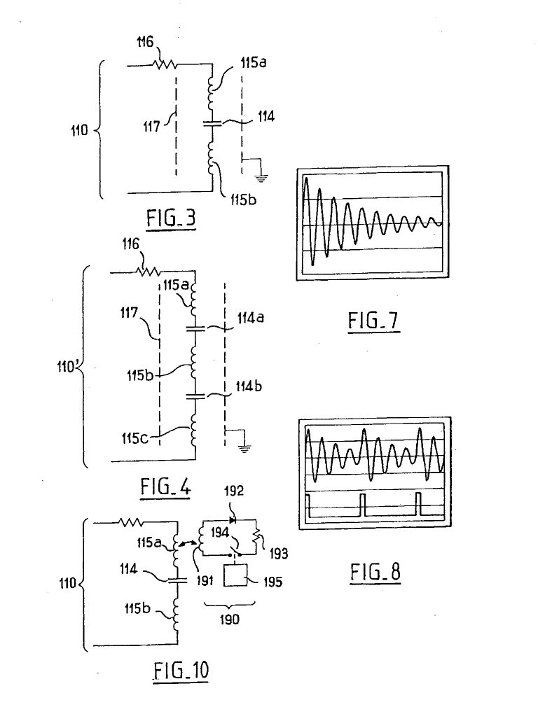

FIG. 3 is a diagram of the antenna,

FIG. 4 is a diagram of a variant of the antenna,

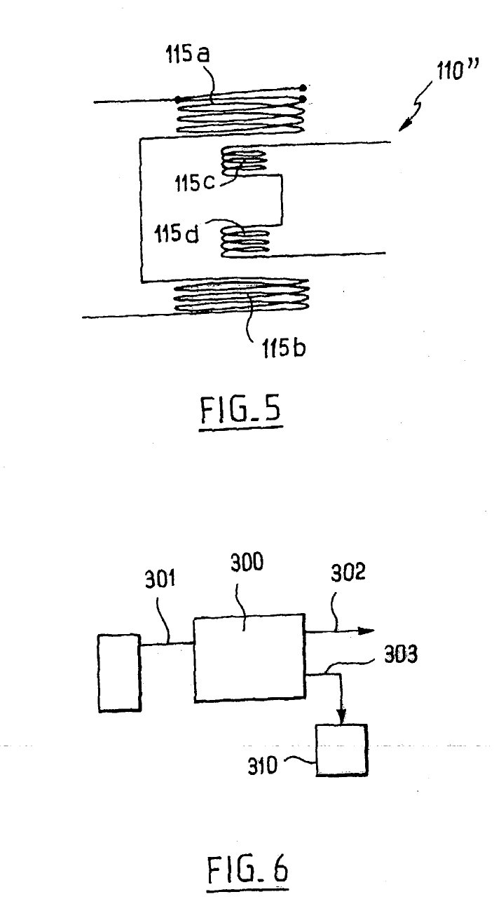

FIG. 5 diagrammatically represents a four-pole antenna,

FIG. 6 is a diagram with directional coupler,

FIG. 7 represents the change of the signal from the read antenna following a pulse,

FIG. 8 represents the signal from the antenna when it is excited in pulsed mode,

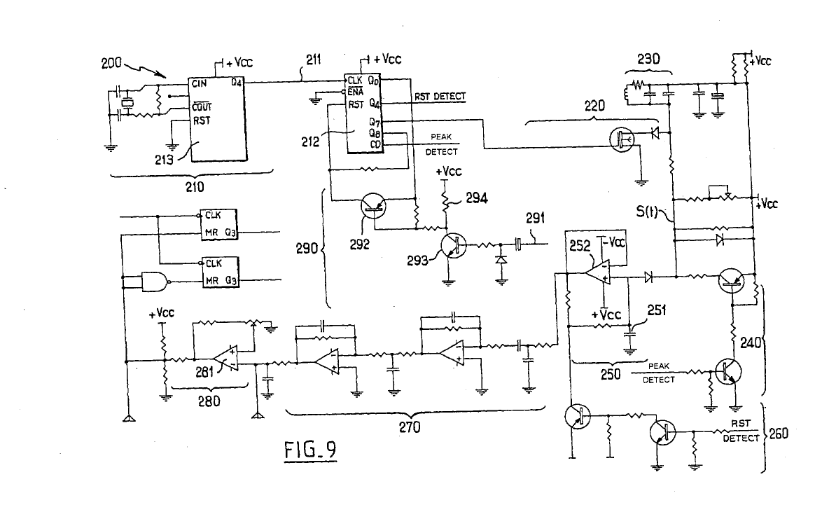

FIG. 9 is a diagram of a read device in accordance with a second embodiment of the invention, and - FIG. 10 represents a device for damping the oscillations of the read antenna.

The read device 100 represented in FIG. 1 is intended to receive information originating from a transponder 10 of a type which is itself known, including a receiving antenna 11 and changeover-switching means 12 making it possible to make the receiving antenna pass from a first state in which it absorbs a relatively low amount of energy to a second state in which it absorbs a larger amount of energy.

The sequence of the changes of state of the receiving antenna 11 is determined by control means 13 internal to the transponder as a function of the information to be transmitted.

The transponder 10 is of small size, and can be encapsulated in a plastic chip having a diameter of the order of one cm.

Reference could usefully be made to the European Patent Application EP 847 023 and to the patent application FR 2 772 164 which refer to the use of such transponders.

The transponder 10 transmits information with a special code, for example a Manchester code which is known in itself.

The read device 100 includes a generator 101 of a signal at a frequency equal to 134.2 kHz in the example described, linked to a power stage 102 operating in class E.

It is also possible to work at 125 kHz.

The class-E switching amplifiers are described especially in the magazine Electronic Applications No. 17, page 25 et seq.

The signal output by the power stage 102 features a low harmonic content.

The amplified signal is sent to a read antenna 110 tuned to the frequency of the generator 101 and comprising, in series, a tuning capacitor 114, an inductor 115 and a resistor 116.

The frequency with which the receiving antenna of the transponder 10 changes state is, for example, less than 16 times, 32 times or 64 times the frequency to which the read antenna is tuned.

The amplified signal output by the power stage 102 is sent to a compensation arm 120.

This compensation arm consists, in the example described, of the combination in series of a capacitor 121, of a fixed inductor 122, of a variable inductor 123, of a fixed resistor 124 and of a variable resistor 125.

The impedance of the compensation arm 120 is equal to a multiple of that of the read antenna 110 in the absence of transmission of information by the transponder 10.

The compensation arm 120 is tuned to the same frequency as the read antenna 110 and exhibits substantially the same quality factor Q.

The read antenna 110 is linked to the power stage 102 by way of a coil 131 wound on a torus 130.

The compensation arm 120 is linked to the power stage 102 by way of a coil 132 wound on the same torus 130 as the coil 131, but in phase opposition, in such a way that the flux in the torus 130 is zero when the impedance of the compensation arm is equal, to within a factor k lying, for example, between 2 and 10, to that of the read antenna 110.

In the embodiment example described, it is arranged that the current in the compensation arm 120, when the flux in the torus 130 is zero, is equal to a sub-multiple of the current in the read antenna 110, so as to limit the power losses by dissipation in the compensation arm 120.

The resistor 124 is thus chosen in such a way that the current in the compensation arm 120 is k times less than that in the read antenna 110 when the flux in the torus 130 is zero.

k is equal to the ratio of the number of turns of the coil 132 to the number of turns of the coil 131, so as to obtain a zero flux in the torus 130 when the current in the read antenna 110 is equal to k times that in the compensation arm 120.

A third coil 133 is wound on the torus 130 in order to deliver a current representative of the flux in it.

When the coupling between the read antenna 110 and the receiving antenna 11 of the transponder 10 is modified by the closing of the changeover-switching means 12, the impedance of the read antenna 110 changes and a non-zero flux appears in the torus 130, which is detected by the coil 133.

The torus 130 performs magnetic subtraction between the current in the read antenna 110 and that in the compensation arm 120, after multiplication by a factor k.

This subtraction makes it possible to suppress the noise from the electronic components of the generator 101 and from the power stage 102 in the signal S(t) from the read antenna.

The compensation arm 120 thus serves to generate a reference signal which makes it possible to eliminate, from the signal from the antenna S(t), the noise due to the electronic components serving to generate the carrier.

The coil 133 is linked to an amplifier 140 which is itself connected to processing means 150, which comprise a multiplier 151 for performing synchronized demodulation of the signal delivered by the amplifier 140 and a multiplier 152 for performing synchronized demodulation of the signal delivered by the amplifier 140 after phase-shifting of the carrier by π/2.

The signal 170 demodulated at 151 is representative of the information transmitted by the transponder and can be directed to a microprocessor or any other signal-processing means capable of decoding this information.

The signal 170 is integrated at 153 so as to constitute an error signal 154 which is used to control the variable resistor 125.

The signal demodulated at 152 is integrated at 155 so as to constitute a quadrature error signal 156 which is used to control the variable inductor 123.

In one variant, not illustrated, the compensation arm includes only a resistor slaved to a value k times larger than the real impedance of the read antenna at the tuned frequency.

However, in this variant, the compensation arm can serve as an exact reference only at the resonant frequency and not over the entire passband determined by the quality factor Q and the filters of the detection stages, such that the noise from the amplifier 102 is not completely eliminated.

The compensation arm 120, in the example illustrated, includes the variable inductor 123 in addition to the variable resistor 125, so as to be further representative of the read antenna.

The resistor 125 of the compensation arm is modified in such a way as to cancel out the error signal 154 and the value of the variable inductor 123 is modified in such a way as to cancel out the quadrature error signal 156.

Thus the slow variations in the impedance of the read antenna 110 are corrected, these being due, for example, to the temperature or to the nature of the objects placed in the field of the antenna.

This slaving makes it possible to maintain the zero flux in the torus 130.

The variable resistor 125 is advantageously an LDR resistor, the value of which varies as a function of the illumination, this resistor being controlled by a light source such as an LED, for example, receiving the error signal 154.

The variable inductor 123 advantageously consists of the secondary of a transformer the primary of which is loaded by an LDR resistor, controlled by a light source such as an LED for example, receiving the quadrature error signal 156.

In the example considered, the transformer used includes 14 turns in the primary and 16 turns in the secondary, these turns being wound on a torus of 1900 μH of inductance per turn squared.

This transformer makes it possible, for a variation from 300 to 2000 Ω in the resistance of the LDR in the primary, to obtain a variation in inductance from 100 to 400 μH at the secondary, with a residual resistance from 300 to 400 Ω.

The variable inductor and the variable resistor can further consist respectively of a network of inductors and a network of resistors, switched in series and/or in parallel by means of relays, in order to obtain the value sought.

It is further possible to use a variable capacitor as a replacement for the capacitor 121, the variable inductor 123 possibly then being replaced by an inductor of fixed value.

The abovementioned variable capacitor may consist, for example, of a network of capacitors of fixed values, switched in series and/or in parallel in such a way as to obtain the desired value.

It is further possible to use motorized components.

In this case, the integrators 153 and 155 are not used.

In a variant represented in FIG. 2, a fourth coil 134 is arranged on the torus 130.

A compensation arm 120′ replaces the arm 120 described above, the variable inductor 123 and the variable resistor 125 being replaced by components of fixed values.

The current in the coil 134 is controlled by an amplifier 164, which receives, as input, a signal delivered by a summer 163.

This summer is fed with signals 165 and 166.

The signal 165 is delivered by a multiplier 161 which multiplies the error signal 154 by the clock signal 167.

The signal 166 is obtained by a multiplier 162 which multiplies the quadrature error signal 156 by the clock signal, phase-shifted by π/2.

The signal 165 corresponds to the clock signal with an amplitude proportional to the error signal 154.

The signal 166 corresponds to a quadrature clock signal with an amplitude proportional to the quadrature error signal 156.

The advantage of the embodiment of FIG. 2 is that of not involving mechanical or optoelectronic components in the compensation arm 120′.

The current in the coil 134 cancels out the flux in the torus 130 due to the slow variations in the impedance of the read antenna 110.

Preferably, as represented in FIG. 3, the read antenna 110 is split into two coils 115a and 115b linked in series via the tuning capacitor 114.

The terminals of the coils subjected to the overvoltages are coincident with those of the tuning capacitor 114.

An electric screening 117 is placed around the coils 115a and 115b, this screening being open at its axial extremities so as to allow articles carrying the transponders to pass.

The terminals of the tuning capacitor 114 are easily positioned within the screening 117, and are thus effectively protected by the latter.

This results in a lower sensitivity of the read antenna 110 to the effects of static potentials and to humidity, as well as better aging of these components.

Needless to say, the read antenna can be split into more than two coils.

By way of example, an antenna 110′ has been represented in FIG. 4 including three coils linked in series by two tuning capacitors 114a and 114b.

With a view to reducing the far magnetic field outside the antenna, it is possible to use a first set of coils and a second set of coils linked together in a way which is known in itself in order to constitute a four-pole antenna the far magnetic field of which decreases as 1/d⁵.

By way of example and very diagrammatically, such an antenna 110″ has been represented in FIG. 5.

The antenna includes two coils 115c and 115d linked in series, placed in the field of two other coils 115a and 115b linked in series.

The objects carrying the transponders are placed in the field of the coils 115c and 115d.

It is possible, by virtue of the four-pole antenna, to reduce the influence which a read antenna may have on an adjacent read antenna, in the case in which several read devices are used in the same enclosure.

It will be noted that the current sent into the read antenna 110 has a low harmonic content such that the read antenna 110 may transmit with high power while complying with the regulations.

In order to bring to light a variation in coupling between the read antenna and the receiving antenna, it is further possible to use an impedance-demodulation device using a directional coupler 300 receiving, as input 301, the signal intended for feeding the read antenna.

The read antenna is linked to the output 302.

The output 303 is representative of the reflected power not absorbed by the read antenna.

When the read antenna is perfectly tuned and when the changeover-switching means of the transponder placed in the field of the antenna are open, the transmitted power is total and the current on the output 303 of the directional coupler 300 is zero.

In contrast, when the antenna of the transponder changes state, the read antenna ceases to be perfectly tuned and the current on the output 303 is no longer zero.

The signal arising at the output 303 can easily be demodulated in synchronous fashion by processing means 310 so as to deliver a signal representative of the information transmitted by the transponder.

By reference to FIGS. 7 to 9, a read device 200 will now be described, in accordance with a second embodiment example of the invention.

This read device 200 includes a clock 210, of conventional design, produced, for example, by means of a binary counter with oscillator 213 of the 74HC4060 type, which delivers a clock signal 211 at 268.4 kHz in the assembly described.

The clock signal 211 is sent to a decimal counter 212 of the 74HC4017 type.

The output Q4 of this decimal counter supplies a pulse signal RST DETECT, the function of which will be described later.

The output Q7 delivers a pulse signal to a power stage 220 linked to the read antenna 230, which here is symbolized by a parallel RLC circuit.

The output Q8 is sent to the zero-reset input RST.

The output CO delivers a signal PEAK DETECT at high level when the counter 212 scans the outputs Q0 to Q4 and of low level when the counter 212 scans the outputs Q5 to Q8.

The free oscillations of the signal S(t) of the read antenna in response to a pulse have been represented in FIG. 7.

It will be noted that the peak amplitude of each pseudo-period decreases.

When the read antenna 230 is excited in pulse mode by the power stage 220, the signal S(t) represented in FIG. 8 is obtained.

The read device 200 is configured to deliver a signal representative of the change over time in the peak amplitude of a predetermined pseudo-period, for example the third one in the example described.

Peak-limiting means 240 are provided so as to peak-limit the signal S(t) from the read antenna when the PEAK DETECT output of the counter 212 is in the high state.

A peak detector 250 makes it possible to keep, at the terminals of a capacitor 251, a voltage representative of the peak amplitude of the pseudo-period selected for the measurements, that is to say the one which follows the end of the peak-limiting of the signal S(t), or the third one in the example described.

The potential of the capacitor 251 is lowered to a predetermined potential just before the measurement of the peak amplitude of the pseudo-period selected, by virtue of initialization means 260 controlled by the RST DETECT signal.

The voltage at the terminals of the capacitor 251 is found again at the output of the operational amplifier 252 and drives a set of bandpass filters 270 configured to eliminate the high-frequency disturbances.

At the output of the bandpass filters 270, the signal is put into logic form by a threshold-effect comparator 280, using an operational amplifier 281.

The logic signal is then decoded by means of a double binary counter of the 74HC393 type and of a NAND gate, the binary counters being driven by the clock signal at 67.1 kHz delivered by the output Q6 of the binary counter 213.

In the read device 200, the signal from the read antenna S(t) is not polluted at the time of the measurement by the noise from the electronic components of the power stage 220, since the transistor of the latter is turned off at the instant when the measurement is taken and everything happens as if the read antenna 230 were isolated.

The peak amplitude of the pseudo-period over which the measurement is taken is measured by comparison with a reference signal which here is constant and chosen to be equal to +VCC, that is to say to the power-supply voltage.

The read devices 100 or 200 which have just been described are advantageously used to write information into the memories of transponders by all-or-nothing modulation of the feed to the read antenna.

In the case of the read device 100, this modulation is obtained, for example, by switching the signal sent to the power stage 102.

In the case of the read device 200, the interruption in the transmission from the read antenna is obtained by virtue of switching means 290 including two transistors 292 and 293.

The sending of a high signal to the base 291 of the transistor 293 has the consequence of turning the transistor 292 on and of sending the output Q0 of the counter 212 to the zero-reset input RST.

During the interruption of the transmission, the current drawn from the general power supply of the read device falls.

In order to avoid the fluctuations in the voltage +VCC disturbing the operation of the read device 200, the transistor 293 becomes conducting upon the cut-off of the field of the read antenna and feeds into a resistor 294 the value of which is chosen in such a way that the consumption of the read device 200 is substantially the same when the read antenna is transmitting and when the transmission is interrupted.

Needless to say, the invention is not limited to the embodiments which have just been described.

For example, in order to avoid free oscillations of the read antenna when it is necessary to interrupt the field thereof in order to write into the memory of the transponders, a device is preferably used ensuring the rapid damping of the oscillations of the read antenna.

In FIG. 10, a damping device 190 has been represented, including a coil 191 coupled with the coil 115a of the read antenna 110, means for rectification of the current 192, dissipation means 193 and switching means 194 controlled by a control circuit 195.

This control circuit 195 is configured to close the switching means 194 immediately after the current sent to the read antenna 110 has been interrupted.

For preference, a gauge transponder is attached to the read antenna 110 or 230, making it possible to test the serviceability of the read device, this transponder possibly being placed in a silent mode at the end of the test phases by sending it a particular piece of information.

Furthermore, it is particularly possible to produce the read device in such a way as to operate at frequencies higher than 150 kHz, for example a few MHz.

The compensation arm 120 can be replaced by an antenna comparable to the read antenna 110, but the read area of which is different.

The electrical power dissipated in the antenna by Joule effect lies, for example, between 1 and 100 W, depending on the extent of the detection volume.

1. A read device (100; 200) including a power stage and a read antenna (110; 230) making it possible to generate an electromagnetic field for excitation of at least one transponder (10) situated in the field of the antenna, this transponder including a receiving antenna (11) and associated changeover-switching means (12) allowing it to modify the state of the receiving antenna and thus to transmit information to the read device, by modification of the coupling between the read antenna and the receiving antenna, the read device being characterized in that it includes detection means which are configured to reduce the noise or the fluctuations, in the signal from the antenna, which are due to the electronic components of the power stage and to generate a useful signal from the change in the signal from the read antenna by comparison with a reference signal, this reference signal being representative of the signal from the read antenna when the receiving antenna of the transponder is in a predetermined state, the useful signal being representative of the changes of state of the receiving antenna.

2. The device as claimed in claim 1, characterized in that the read device includes communications means (220) which are configured to feed the read antenna (230) in pulsed mode and in that the read device includes processing means which are configured to perform damping demodulation of the signal from the read antenna after each pulse.

3. The device as claimed in the preceding claim, characterized in that the processing means include a peak detector (250) in order to preserve the peak amplitude of the signal from the read antenna over a predetermined pseudo-period.

4. The device as claimed in the preceding claim, characterized in that the processing means include peak-limiting means (260) for peak-limiting the signal from the read antenna over a predetermined period preceding the pseudo-period selected for the measurement.

5. The device as claimed in claim 1, characterized in that the read antenna is excited by a signal with a low harmonic content, preferably output by a class-E switching amplifier (102), and in that the read device includes processing means configured to perform impedance demodulation.

6. The device as claimed in claim 1, characterized in that the reference signal is obtained by means of a compensation arm (120) the impedance of which is equal, to within a known factor, to that of the read antenna (110) when the receiving antenna is in a first predetermined state.

7. The device as claimed in the preceding claim, characterized in that it includes a torus (130) with three coils, including a first coil (132) linked in series with the compensation arm (120), a second coil (131) linked in series with the read antenna (110) and mounted in phase opposition with the first coil, in such a way that the flux in the torus (130) is zero when the impedance of the antenna is equal, to within a known factor, to that of the compensation arm, and a third coil (133) making it possible to detect a flux variation in the torus.

8. The device as claimed in the preceding claim, characterized in that the compensation arm (120) includes variable components (123; 125) which are controlled in such a way as to cancel out the flux in the torus (130) due to the slow variations in the impedance of the read antenna.

9. The device as claimed in claim 7, characterized in that the compensation arm (120′) includes components of fixed values, and in that the torus (130) includes a fourth coil (134) supplied with current in such a way as to cancel out the flux in the torus (130) due to the slow variations of the read antenna.

10. The device as claimed in claim 1, characterized in that it includes a directional coupler (300) configured in such a way that a modification of the coupling between the read antenna and the receiving antenna gives rise to a useful signal which is representative of the de-tuning of the read antenna induced by the changes of state of the receiving antenna.

11. The device as claimed in any one of the preceding claims, characterized in that the read antenna is split into at least two coils (115a, 115b) linked in series by a tuning capacitor (114), these coils being arranged within a screening (117) open at at least one of its axial extremities, so as to allow articles equipped with transponders to pass into the antenna.

12. The device as claimed in any one of the preceding claims, characterized in that the read antenna (110″) includes a first set of coils (115c, 115d) arranged within the field produced by a second set of coils (115a, 115b), these coils being linked together in such a way as to constitute a four-pole antenna, outside which the far magnetic field decreases as 1/d⁵.

13. The device as claimed in any one of the preceding claims, characterized in that the transmission frequency of the read antenna preferably lies between 100 and 150 kHz and in that the frequency with which the receiving antenna is switched is at least 16 times lower.

14. The device as claimed in any one of the preceding claims, characterized in that the read antenna is configured to receive a container including a plurality of articles each equipped with a transponder.

15. The device as claimed in any one of the preceding claims, characterized in that it includes a gauge transponder fastened to the read antenna, this transponder being active during test phases and possibly being placed in a silent mode when said test phases are terminated.

16. The device as claimed in any one of the preceding claims, characterized in that the transponders used are of the read and the write type, and in that the read device includes changeover-switching means making it possible to modulate the feed to the read antenna in all-or-nothing mode, so as to transmit information to the transponders placed in the field of the antenna.

17. The device as claimed in the preceding claim, characterized in that it includes a circuit (190) for damping the oscillations of the read antenna, comprising changeover-switching means for linking a coil (191) placed in the field of the read antenna or a reactive element of the antenna to a dissipative load (193), when it is necessary to damp the oscillations of the antenna rapidly.

18. A set of devices as defined in any one of the preceding claims.

19. A set as claimed in the preceding claim, characterized in that the clocks of the devices are synchronized.

20. A set as claimed in one of the two preceding claims, characterized in that the devices are driven in such a way that none of them operates in write mode when another one is operating in read mode.
